(19) United States
(12) Patent Application Publication
(10) Pub. No.: US 2007/0079287 A1
(43) Pub. Date: Apr. 5, 2007

(54) Incorporating qualified, polymorphic, hedge-regular types into computer-programming languages

(75) Inventors: Allen L. Brown JR., Bellevue, WA (US); Matthew D. Fuchs, Los Gatos, CA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/320,122

(22) Filed: Dec. 28, 2005

Related U.S. Application Data
(60) Provisional application No. 60/723,526, filed on Oct. 4, 2005.

(51) Int. Cl. G06F 9/44

(52) U.S. Cl. 717/114

(57) ABSTRACT

Systems and methods for incorporating qualified, polymorphic, hedge-regular types into computer-programming languages are disclosed. A programming language having such a type system, and a typing system for such a programming language are also disclosed. Also described is Haxell, an effort to completely integrate regular hedge pattern-matching into Haskell. Haxell is a Haskell embodiment of a set of concepts that may be applied to any of a number of functional and/or traditional languages.

### CROSS-REFERENCE TO RELATED APPLICATIONS

This application claims benefit under 35 U.S.C. § 119(e) of provisional U.S. patent application No. 60/723,526, filed Oct. 4, 2005, the disclosure of which is incorporated herein by reference.

### BACKGROUND

In any typed programming language, there will be programs that are syntactically and semantically correct, but the typing system associated with the language will be unable to type them. As a result, the typing system may allow a programmer to write syntactically- and semantically-correct programs that do not work.

A typical typing system for a programming language is applied by a compiler associated with the language. Program typing largely happens by the compiler's inferring the type. For a typing system to be practical, it must produce an answer, and it must do so in a reasonable amount of time.

A programming language may employ one or both of two typing paradigms. According to the first paradigm, which is employed by scripting languages such as JavaScript and PERL (Practical Extraction and Reporting Language), for example, the programmer is not required to type expressions (e.g., variables, functions, etc). Accordingly, a compiler associated with such a language will not perform any type-checking on the source code. Consequently, a program written in such a language will work—unless it doesn't. According to the second paradigm, the programmer is required to type every expression. Accordingly, a compiler associated with such a language will confirm that the programmer-supplied typing of expressions is consistent throughout the program.

Functional languages that have type systems are descendants from a theoretical system known as “System F.” In System F, any expression can be typed—manually. Accordingly, a programming language could merely require the programmer to type everything manually. To simply the programmer's life, however, it is desirable that expressions be typed automatically, if possible. In most modern functional languages, some typing can be done automatically. Of course, when typing is done automatically, a much smaller class of expressions can be typed than could be typed manually. It would be advantageous, especially from the programmer's point of view, if the programmer were not required to type anything. If too little is typed manually, however, the compiler might get stuck, i.e., the typing system might not be able to type within a reasonable amount of time, or at all. As discussed above, this would be unacceptable—the typing system must produce an answer, and it must do so in a reasonable amount of time. A balance must be struck, therefore, between automatic and manual typing. That is, a goal is to allow for typing of the greatest number of expressions, with the least amount of programmer-supplied annotation.

Consider the operator “+,” for example. The purpose of the operator “+” is to add two operands. The operator must ascertain that, whatever the operands are, there is a function that it can use to add them together. Typically, therefore, the operator “+” may be limited to adding two numerical operands. In notation, +: num(α)=>(α−>(α−>α)). Typically, therefore, the operator “+” may be said to be of qualified, parametric polymorphic type because the parameters, α, must be numericals for the operator to work. Very powerful constraints can be set on what qualifiers are.

Now consider a function of lists called LENGTH that determines the number of elements in a list, where a list could include elements of various and different types. LENGTH may be said to be of unqualified, polymorphic type because LENGTH does not care what the type is of the things in the list, only how many of them there are. Without polymorphism, a different “length” function would be needed for each type of list. Thus, qualified typing is a powerful way to achieve polymorphism.

Data structures in programming languages typically include one or more trees. An example of such a tree is depicted in FIG. 1. To make a data structure useful, a labeling scheme is usually required in order to ensure that a unique way exists to get to every node.

A “hedge” is an ordered list of items. An ordered sequence of trees may be referred to as a hedge. An untyped hedge is a list of things in the hedge in whatever order they happen to appear. An example of this is XML, which has no typing system. Hedge type specifies what the order of things in a hedge should be. A hedge type is basically an XML document (or list of XML documents) or something that can be considered like that. The typing system indicates what kinds of hedges are legal for the programmer to assemble. A hedge-regular type may be expressed via the algebra of regular expressions. The concept of regular expressions is well-known, and need not be described herein in detail. A hedge-regular type may be considered polymorphic if, wherever there appears a sub-expression in a type expression, parametric variables appear in the algebra.

In the world of Internet commerce, for example, it is often necessary or desirable to write programs that manipulate SOAP messages. In XML, for example, programmers often cannot exactly express the “contract” between the programmer and the machine because the typing system is not powerful enough. Typically, the issue is addressed by the programmer's typing an expression as being of type “any” when, in fact, the expression cannot really be of any type.

Similarly, one or more contracts may exist between the implementer of a service (a.k.a., the “supplier”) and the caller of the service (a.k.a., the consumer). The service may be obliged to do something when it receives a SOAP message. Accordingly, the caller may invoke the service by sending a SOAP message to the service. To make such a system work, the implementer and caller need to know what kinds of things are allowed to be in the message.

Also, a contract may exist between the supplier and the consumer in terms of the order in which things may be done. For example, when two organizations do business with each other, the consumer typically sends a purchase order to the supplier, the supplier then sends an acknowledgement back to the consumer, the consumer then sends a payment to the supplier, and the supplier then provides the ordered goods to the consumer.

A contract may exist between the implementer and caller about the documents that are exchanged, e.g., what goes into a purchase order, payment, etc. The implementer and the caller must each know what it is to send, and what it should expect to receive. The typing system is expected to tell the programmer whether the document is structurally correct (in terms of hedge-type). For example, the typing system should not be expected to determine whether the document includes the correct dollar amount for a purchase, but it should be expected to determine whether the dollar amount is a numerical and has two decimal places.

Qualified type mechanisms have been used to incorporate hedge-regular types into functional languages, but not in a polymorphic fashion. It would be desirable, however, if a mechanism were available to incorporate qualified, polymorphic, hedge-regular types into a computer-programming language.

Additional background pertaining to typed functional languages (e.g., System F, ML, CAML, F#, Haskell98, GHC) may be found at:
http://en.wikipedia.org/wiki/Functional programming
http://mitpress.mit.edu/catalog/item/default.asp?ttype=2&tid=8738
http://mitpress.mit.edu/catalog/item/default.asp?ttype=2&tid=3460
http://www.cambridge.org/us/catalogue/catalogue.asp?isbn=0521594146.

Additional background pertaining to type inference in functional languages (e.g., ML, CAML, F#, Haskell98, GHC) may be found at:
http://en.wikipedia.org/wiki/Type inference
http://www.cambridge.org/us/catalogue/catalogue.asp?isbn=0521465184
http://mitpress.mit.edu/catalog/item/default.asp?ttype=2&tid=8738
http://mitpress.mit.edu/catalog/item/default.asp?ttype=2&tid=3460
http://www.cambridge.org/us/catalogue/catalogue.asp?isbn=0521594146.

Additional background pertaining to data construction and access in functional languages (e.g., ML, CAML, F#, Haskell98, GHC) may be found at:
http://en.wikipedia.org/wiki/Algebraic data types
http://mitpress.mit.edu/catalog/item/default.asp?ttype=2&tid=8738
http://mitpress.mit.edu/catalog/item/default.asp?ttype=2&tid=3460
http://www.cambridge.org/us/catalogue/catalogue.asp?isbn=0521594146.

Additional background pertaining to qualified types and type inference in functional languages (e.g., GHC) may be found at:
http://citeseer.ist.psu.edu/cache/papers/cs/21219/http:zSzzSz129.95.50.2zSz˜mpjzSzpubszSz rev-qual-types.pdf/jones92theory.pdf
http://www.cambridge.org/us/catalogue/catalogue.asp?isbn=0521472539.

Background pertaining to structured message process calculi may be found in U.S. patent application Ser. No. 10/881,142, filed Jun. 30, 2004.

### SUMMARY

A programming language having a type system that includes qualified, polymorphic, hedge-regular types is disclosed. A typing system for such a programming language is also disclosed.

Specifically described herein is a set of patterns allowing bounded decision-making among themselves for potentially infinite computations. Previous work has not looked at the impact of patterns on lazy computation, only on costs of processing finite trees (which may be exponential).

Concepts disclosed herein include combinations of 1) hedge-regular data, 2) hedge-regular grammars as types, inferences of such types, checking against such types, and sub-typing according to such types, 3) regular pattern-matching, and 4) type variables that can be sub-expressions of type expressions, yielding polymorphism.

Also described is Haxell, an effort to completely integrate regular hedge pattern-matching into Haskell. It should be understood that Haxell is a Haskell embodiment of a set of concepts that may be applied to any of a number of functional and/or traditional languages. A goal of this effort is for both types of data to be treated seamlessly. Other work along these lines (e.g., XHaskell) requires a large scale rewriting of the source program and the generation of a large number of new classes. However, Haskell's current type inference algorithm can determine which constraints need to be satisfied, and the additional type checking can be done through modifying the type checker or as a callout from type checking.

The approach to patterns disclosed herein is unique in its use of “weak” wildcards. The notion of weak wildcards grew out of work with XML Schema. However, they have not been previously considered in this context. The significance here is that wildcards are very important to pattern matching. However, in pattern matching with regular expressions, wildcards must be either severely restricted or a degree of non-determinism is introduced.

A wildcard is something that matches anything in an input pattern. For example, in a pattern (_|B), the wildcard (i.e., the “_”) normally can match “B,” as can the “B.” This introduces non-determinism. With a weak wildcard, the wildcard specifically cannot match B, so the pattern remains deterministic. Weak wildcards avoid the non-determinism by specifically not matching any conflicting particle.

Also, as disclosed herein, regex pattern matching may be extended with parametric polymorphism. An algorithm for this based on unambiguous patterns is described. Part of this involves determining constraints on type variables. These constraints may be maintained in the context for types with variables, leading to the use of qualified types. Type variables can be unified with any other type that does not break these constraints. Other work on polymorphism has not used qualified types, and other work using qualified types does not support polymorphism.

### BRIEF DESCRIPTION OF THE DRAWINGS

FIG. 1 is a block diagram showing an example computing environment in which aspects of the invention may be implemented.

### DETAILED DESCRIPTION

As described herein, a functional computer-programming language may be extended with hedge-regular types, hedge-regular patterns, and hedge-regular data, where the types enjoy parametric polymorphism. Algorithms for type inference, type subsumption, and data pattern-matching have been developed based on unambiguity. Part of this involves determining constraints on type variables. These constraints are maintained in the context for types with variables, leading to the use of qualified types. Type variables can be unified with any other type that does not break these constraints. Other work on polymorphism has not used qualified types, and other work using qualified types does not support polymorphism. The other important aspect of this work is the use of weak matching. Both will be explained here.

Type Variables and Unification

A value is a tree analogous to a list of XML items, e.g.,
<foo>True</foo><bar>10</bar><bar>20</bar><baz>“some text”</baz>
however we write it in shorter form as
:foo[True] :bar[10] :bar[20] :baz[“some text”].

A type is an expression to describing a set of values. It includes regular expressions over elements (such as :foo[ ], and :bar[ ]), basic types (such as Num, Bool, and String), and type variables. The contents of the element (such as :foo[ ]) is also described by some type. One type may be the type of values of a foo element containing a Boolean value, followed by any number of bar elements containing integers, ending with a baz element with some text. A type for this would be:
(|:foo[Boo1], :bar[Integer]*, :baz[String]|).
However, this nails down the types quite specifically. Suppose we wanted to write a function that changed all the element names from foo to oof, bar to rab, and baz to zab. The type of this function would have to be
flipName:: (|:foo[Boo1], :bar[Integer]*, :baz[String]|)−>(| :oof[Boo1], :rab[Integer]*, :zab[String]|)
even though the contents of foo, bar, and baz are irrelevant.

Haskell allows type variables, which would allow one to describe all types with foo followed by any number of bars terminated by a baz as:
(|:foo[t1], :bar[t2]*, :baz[t3]|),
where t1, t2, and t3 are type variables. Now the type of flipName can be described as
flipName:: (|:foo[t1], :bar[t2]*, :baz[t3]|)−>(|:oof[t1], :rab[t2]*, :zab[t3]|).
The function can now work on any value of the corresponding types. It does mean that all bar elements must contain the same type.

Eventually there will be functions that want to do things with the contents of the elements. For example, if all the bar elements contain numbers, one could add them up. Such a function might be:
addem (|:foo[_], :bar[x]*, :baz[_]|)=fold (+) x.
However, the type of this function can't be
addem:: (|:foo[t1], :bar[t2]*, :baz[t3]|)−>Integer
because addition only applies to numbers. Also, not all numbers are integers, so there is no particular reason to constrain the result to be an integer when it could be any kind of number.

Haskell handles this by using qualified types. In this case, we need the contents of bar's to be a subtype of Num (the general Haskell type of all numbers, or which Integers and Reals are subtypes), and we want the result to be of the same type. We can express this with the following qualified type:
addem::(Num t2)=>(|:foo[t1], :bar[t2]*, :baz[t3]|)−>t2.
The additional constraint specifies that any type to replace the variable t2 must be of type Num, and that the result of the function is of that same type.

If we then want to call addem with a value, we make sure that the value is of compatible type. Suppose we have a value of type
(|:foo[Boo1], :bar[Integer]*, :baz[String]|)
from above. The Haxell type checker, will compare this type with above and associated t1 with Boo1, t2 with Integer, and t3 with String. It will then examine its constraints and determine that Integer is a subtype of Num and everything is fine.

Alternatively we could have
|:foo[String], :bar[Double]*, :baz[Char]|).
This would also be OK because Double is still a Num. However,
(|:foo[String], :bar[String]*, :baz[Char]|)
would not work, as String is not a Num.

The importance of the context comes when one considers that types can be used to construct other types. In Haxell we can create a type: Foo t1 t2 t3=(|:foo[t1], :bar[t2]*, :baz[t3]|). Thus, Foo is a foo element, followed by some number of bar elements, followed by a baz element. A foo may contain either a list of integers or a string. A bar may contain children matching Foo. Later one may specify: Bar=Foo String Integer Boo1, rendering a new type. It is desirable to be able to construct new types without looking into the nitty gritty.

Another area of importance for this work is the use of weak matching. Suppose one has, as a type,
(|(:foo[ ], t1)|(t2, :bar[ ])|)
Normally this would be ambiguous, as t2 could match :foo and t1 could match :bar. However, with weak matching, we exclude t2 from starting with :foo and thereby resolve the ambiguity. An even worse case than this is (|t1 |t2 |). However, with a constraint we can specify that the first elements in t2 and t1 must be disjoint.

A final area of concern for us is limiting the amount of look ahead required to match a pattern. Pattern variables corresponding to optional data may be translated to lists. This could be done using Maybe, for example. In Haskell it is possible to several alternatives that are distinguished by patterns, which take roughly the same form as types. For example our version of addem might be changed to do a different operation depending on the type of bar:
addem (|:foo[_], :bar[x@Integer]*, :baz[_]|)=fold (+)x
addem (|:foo[_], :bar[x@Float]*, :baz[_]|)=fold (*)x
addem (|:foo[_], :bar[x@Double]*, :baz[_]|)=fold (/)x
Given the possibility of divergent computation, it's important that patterns match in bounded time. This has not been generally recognized and testing patterns for this will be part of the implementation.
Haxell, an Effort to Completely Integrate Regular Hedge Pattern-matching into Haskell

XHaskell is a brilliant hack. However, it depends on generating lots of extra classes and requiring explicit type annotations throughout the source code to explicitly indicate subsumption relations. With far less annotations, the type checker will enumerate exactly the required relationships as errors. Therefore a goal of the invention is to integrate the hedge type checking, based on subsumption, into GHC.

Haxell is similar to Cduce and πDuce in pattern matching. It does not support negative patterns. Haxell is similar to XHaskell, except that Haxell provides for integrating type checking into the compiler rather than continuing with generating types, supports parametric polymorphism, requires fewer type annotations, and the compiler “knows” which subsumption checks need to be made.

Haxell includes an extended syntax (e.g., hacked Haskell grammar). Haxell may be translated into “standard” Haskell, though such translation may require some apparently obscure declarations. Subsumption checks (e.g., if “-O”) are performed once, at runtime, and then resolve to True. A Haskell type may be converted to a hedge by calling “marshal.” In many cases the compiler knows what type to marshal it to, so there is no need to specify. This may also be able to be subsumed under “Cast.” Thus, marshal/unmarshal between Haskell's types and regular types is possible, as defined by the user.

A newtype may be generated for every regular type. A newtype may either be defined by the programmer, or generated from a pattern in a match. Each pattern also generates a tuple type corresponding to the bound variables. Also, instances of class XMark provide information for validation, casting to/from the type, and pattern matching (pattern match returns either tuple error-message). A structure containing all regex's may be generated for validating and pattern matching. An implementation of Haxell may be embedded in a compiler.

The following example regex type:

```
      regex Envelope =
        (|:envelope[:headers[Header**]??,
        :body[Any**]]|)
may become
      newtype Envelope = Envelope [Tree]
      Instance XMark Envelope ( ) where
        -- “type” a hedge as an Envelope
        create x = Envelope x
        -- remove type so x can be cast to another type
        decreate (Envelope x) = x
        -- type name to be passed to validator
        value x = “Envelope”
        The following pattern example:
      f(|:integers[int@Integer]**
        :strings[str@String]**|) = ....
may become
      newtype Gensym0 = Gensym0 [Tree]
      type Gensym1 = ([Integer], [String])
      instance XMark Gensym0 Gensym1 where
        ... as above ...
        -- pattern variable names
        varList x = [“int”, “str”]
        -- convert results of pattern match to a Gensym1 tuple
        toTuple _{—} (Right [int, str]) =
            Just (create int, create str)
        toTuple _{—} (Left errormessage) = error errormessage
```

The newtype is the same as in the last example, but the tuple corresponds to the values matched by the pattern. In fact, the left side of toTuple ought to distinguish between a failure to parse, which would fall to the next alternative, or some bigger error. The parser just returns the bound variables in an array that is converted to a tuple and “stamped” with the correct regex types (determined by the return sig of the method). That way the values are available in the body of the pattern with their names.

In the following example instances of Cast where trees must be cast from one type to another, given foo::Foo->Bar and bar::Bar, (foo bar) requires Bar<: Foo check. Given instance Cast Bar Foo, foo (cast bar) does the right thing. One runtime check (if (Bar<: Foo) then . . . ) becomes (if True then . . . ) if compiled with -O. These instances may be added manually. That is, the programmer may be required to change (foo bar) to (foo (cast bar)). In that case, the compiler will list all the instances to be inserted. It is desirable, however, to automate this.

As with all similar type systems, types are related by language inclusion—Bar<: Foo if L(Bar)<L(Foo). XHaskell uses type annotations to figure out where these must be. Basically, Cast Bar Foo has a member: cast (x)::a->b=if (a<: b) then create (decreate x))—with a instantiated to Bar and b instantiated to Foo and x starting as (Bar y). Note that with the approach of “drop that boilerplate,” one can put cast around everything.

An example of Serialize/Deserialize is: class Castor regtype algebraic section. Given deserialize::section->algebraic, then, for any regtype, given cast::regtype->section there is
deserialize::regtype->algebraic
class Xmlable algebraic regtype
   Much of this is very similar to patterns in “Scrap Your Boilerplate” (http://www.cs.vu.nl/boilerplate/). In particular, our “cast” is a slight generalization of the one in that paper.

It is anticipated that an implementation of Haxell may provide for compile-time type checking inside GHC, removal of most runtime checks and generated code, default (de)serialization for algebraic types with user override, and parametric polymorphism and type inference supporting infinite hedges.

Haxell may also provide for laziness and (non)determinism. Suppose a function with an infinite hedge, such as, f[([ :int[x] ])|x<-[1 . . . ]], is called. Suppose we have patterns f(|:int[a@Int]?, (:int[b@Int],:int[c@Int])*|)=. . . No assignment will occur until it is finished, and it will diverge while matching. Next consider:
f(|:int[a@Int]?|)= . . .
f(|(:int[b@Int], :int[c@Int])+|)= . . .
f(|:int[a@Int], (:int[b@Int], :int[c@Int])+|)= . . .
Each is deterministic, but cannot be distinguished in bounded time, so it will diverge. A third example, f(|(:int[b@Int], :int[c@Int])*, :int[a@Int]?|)= . . . , matches in bounded time, and allows processing of b and c, but accessing a will diverge.

Given a set of alternative patterns, it is desirable to know whether a determination can be made, in bounded time, as to which pattern matches. Also, having done so, it is desirable to know whether processing on the right hand side of the math can start in bounded time, or whether the entire document need to be processed in advance. Only the third of these patterns has this property. For the last alternative, it is preferred that matching and assignment should happen in bounded time, as in ordinary Haskell.

An example implementation of Haxell, is provided in the Appendix. Note that the kleene operators **, ++, and ?? make it easier for hacking the parser.

Example Computing Environment

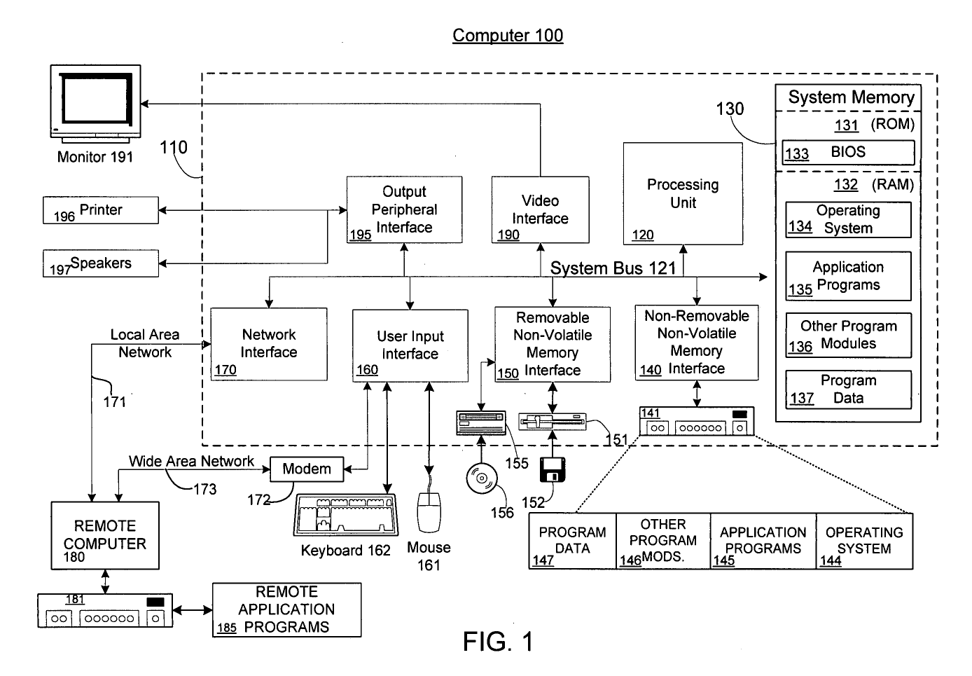

FIG. 1 and the following discussion are intended to provide a brief general description of a suitable computing environment in which an example embodiment of the invention may be implemented. It should be understood, however, that handheld, portable, and other computing devices of all kinds are contemplated for use in connection with the present invention. While a general purpose computer is described below, this is but one example. The present invention also may be operable on a thin client having network server interoperability and interaction. Thus, an example embodiment of the invention may be implemented in an environment of networked hosted services in which very little or minimal client resources are implicated, e.g., a networked environment in which the client device serves merely as a browser or interface to the World Wide Web.

Although not required, the invention can be implemented via an application programming interface (API), for use by a developer or tester, and/or included within the network browsing software which will be described in the general context of computer-executable instructions, such as program modules, being executed by one or more computers (e.g., client workstations, servers, or other devices). Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, minicomputers, mainframe computers, and the like. An embodiment of the invention may also be practiced in distributed computing environments where tasks are performed by remote processing devices that are linked through a communications network or other data transmission medium. In a distributed computing environment, program modules may be located in both local and remote computer storage media including memory storage devices.

FIG. 1 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 1, an example system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, random access memory (RAM), read-only memory (ROM), Electrically-Erasable Programmable Read-Only Memory (EEPROM), flash memory or other memory technology, compact disc read-only memory (CDROM), digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above should also be included within the scope of computer readable media.

The system memory 130 includes computer storage media in the form of volatile and/or nonvolatile memory such as ROM 131 and RAM 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137. RAM 132 may contain other data and/or program modules.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120a-f through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. In addition to monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

One of ordinary skill in the art can appreciate that a computer 110 or other client devices can be deployed as part of a computer network. In this regard, the present invention pertains to any computer system having any number of memory or storage units, and any number of applications and processes occurring across any number of storage units or volumes. An embodiment of the present invention may apply to an environment with server computers and client computers deployed in a network environment, having remote or local storage. The present invention may also apply to a standalone computing device, having programming language functionality, interpretation and execution capabilities.

### Appendix

A Haxell code example is provided below:

```
module Xcomplex where
  import Data.Complex
  -- necessary instances specifically requested by the compiler
  instance (Cast CompR ZZ_0_9 ( ) ZZ_0_10)
  instance (Cast CompR ZZ_0_12 ( ) ZZ_0_13)
  instance (Cast CompR ZZ_0_15 ( ) ZZ_0_16)
  instance (Cast CompP ZZ_0_18 ( ) ZZ_0_19)
  instance (Cast CompP ZZ_0_21 ( ) ZZ_0_22)
  instance (Cast ComplX ZZ_0_24 ( ) ZZ_0_25)
  instance (Cast ZZ_0_25 CompR ( ) ( ))
  instance (Cast ComplX ZZ_0_28 ( ) ZZ_0_29)
  instance (Cast ZZ_0_29 CompP ( ) ( ))
  instance (Cast CompList ZZ_0_33 ( ) ZZ_0_34)
  instance (HedgeMap ComplX AnInt ZZ_0_34 Tree ( ) ( ) ( ) ( ))
  instance (HedgeCall CompList MagList CompList MagList ( ) ( ) ( ) ( ))
  instance (Cast ComplX ZZ_0_2 ( ) ZZ_0_3)
  instance (Cast ZZ_0_4 [Integer] ( ) ( ))
  instance (Cast ZZ_0_5 [Integer] ( ) ( ))
  instance (Cast ZZ_0_6 [Integer] ( ) ( ))
  instance (Cast ZZ_0_7 [Integer] ( ) ( ))
  instance (Cast ZZ_0_39 ComplX ( ) ( ))
  instance (Cast CompList ZZ_0_38 ( ) ZZ_0_39)
  instance (Cast CompList ZZ_0_43 ( ) ZZ_0_44)
  instance (Cast ZZ_0_54 ComplX ( ) ( ))
  instance (Cast ZZ_0_55 ZZ_0_48 ( ) ( ))
  instance (Cast ZZ_0_55 ZZ_0_50 ( ) (ZZ_0_54, ZZ_0_55))
  instance (Cast ZZ_0_44 ZZ_0_55 ( ) ( ))
  instance (Cast CompList ZZ_0_58 ( ) ZZ_0_59)
  instance (HedgeMap ComplX AnInt ZZ_0_59 AnInt ( ) ( ) ( ) ( ))
  -- some types - I thought I had references working (such as having X = (Y | Z)
where Y and Z are both regex's
  -- but I'll need to revisit that
  -- complex number with rectangular or polar coordinates
  regex ComplX = (| :complex[ (:real[Integer], :imag[Integer] ) |
(:mag[Integer], :phase[Integer] ) ] |)
  -- rectangular coordinates
  regex CompR = (| :complex[:real[Integer], :imag[Integer]] |)
  -- polar coordinates
  regex CompP = (| :complex[:mag[Integer], :phase[Integer]] |)
  -- list of complex numbers
  regex CompList = (| :compList[ :complex[ (:real[Integer], :imag[Integer] ) |
(:mag[Integer], :phase[Integer] ) ]** ] |)
  -- list of integers
  regex MagList = (| :integers[ :int[Integer]++ ] |)
  regex AnInt = (| :int[Integer] |)
  -- note among these two that one marshals to polar coordinates, while the
other marshals to
  -- rectangular coordinates.
  -- serialize a complex number to a hedge
  instance (RealFloat a) => Xmlable (Complex a) CompP ( ) where
    toXml _{—} (x :+ y) = decreate ((makeMe (round x) (round y))::CompP)
  -- serialize a complex number to a hedge
  instance (RealFloat a) => Xmlable (Complex a) ComplX ( ) where
    toXml _{—} (x :+ y) = decreate ((makeMe (round x) (round y))::CompR)
  -- deserealize a hedge to a complex number
  instance (RealFloat a) => Castor ComplX (Complex a) ZZ_0_2 ( ) ZZ_0_3 where
    parsedValue _{—} = error “parsed value”
    unmarshal (| :complex[ ( :real[ r @ Integer ] , :imag[ i @ Integer ] ) | (
:mag[ m @ Integer ] , :phase[ p @ Integer ] ) ] |) =
        -- all of these casts can be removed with a little more up front
analysis (the system currently creates new types for
        -- each variable but doesn't do the analysis to realize they are just
Ints.
        if length ( (cast r)::[Integer] ) > 0
          then
            fromInteger (head ((cast r)::[Integer] )) :+ fromInteger (head
((cast i)::[Integer] ))
          else
            mkPolar (fromInteger (head ((cast m)::[Integer] ))) (fromInteger
(head ((cast p)::[Integer] )))
  -- helper function to convert from radians to degrees so I can stick with
integers
  r2d x = (180 * x)/3.1415962
  class CompClass a where
    magnit :: a -> Integer
    aphase :: a -> Integer
    realPart :: a -> Integer
    imagPart :: a -> Integer
    makeMe :: Integer -> Integer -> a
  -- just to show that regex types can be instances of various classes
  instance CompClass CompR where
    magnit (| :complex[ :real[x@Integer], :imag[y@Integer]] |) = (round . sqrt)
(fromInteger (x\hat{ }2 + y\hat{ }2))
    aphase x = error “foo”
    realPart (| :complex[ :real[x@Integer], :imag[y@Integer]] |) = x
    imagPart (| :complex[ :real[x@Integer], :imag[y@Integer]] |) = y
    makeMe x y = ([ :complex[ :real[( [Int x] )] :imag[( [Int y] )]] ])
  instance CompClass CompP where
    magnit (| :complex[ :mag[x@Integer], :phase[y@Integer]] |) = x
    aphase (| :complex[ :mag[x@Integer], :phase[y@Integer]] |) = y
    realPart x = error “foo”
    imagPart x = error “bar”
    -- I “cheat” and use Complex to do my work for me
    makeMe x y = ([ :complex[ :mag[( [Int magn] )] :phase[( [Int phs] )]] ])
      where inter = (fromInteger x) :+ (fromInteger y)
            magn = (round . magnitude) inter
            phs = (round . r2d . phase) inter
  -- use class mechanism to get magnitudes of a complex hedge
  getMag::ComplX->AnInt
  getMag (| r @ :complex[ (:real[Integer], :imag[Integer] )] |) = ([ :int[ (
[Int res ] ) ] ])
    where
          res = magnit ((cast r)::CompR)
  getMag (| r @ :complex[ (:mag[Integer], :phase[Integer] )] |) = ([ :int[ (
[Int res ] ) ] ])
    where
          res = magnit ((cast r)::CompP)
  -- this is a point at which unification would be great, as we know the type of
the contents of CompList and it's
  -- easy to see that (| CompR, CompP, CompR |) <: (| ComplX** |)
  compls = ([ :compList[ ( foo ) ] ])::CompList
    where foo = concat [decreate ((makeMe 10 10)::CompR), decreate ((makeMe 4
8)::CompP), decreate ((makeMe 8 12)::CompR)]
-- where foo = concat (map decreate ( [(makeMe 10 10)::CompR, (makeMe 4
8)::CompR, (makeMe 8 12)::CompR] ))
  -- get the list of magnitudes using hedgemap - a version of map that works
over hedges and hides all the casting
  -- it's acutally implemented as a class to get the right type associations
  magList::CompList->MagList
  magList (| :compList[compls@(:complex[Wild, Wild]++ )] |) = ([ :integers[
(ints) ] ])
      where ints = hedgemap getMag compls
  -- likewise hcall internalizes a lot of casting with a class
  res = (hcall magList compls)::MagList
  r1 = ([ :complex[:real[10] :imag[5]] ])::ComplX
  -- create a Complex from a hedge
  r2 = (unmarshal r1)::(Complex Float)
  r3 = ([ :compList[:complex[:real[10] :imag[5]] :complex[:real[6] :imag[4]]]
])::CompList
  -- there may be any number of types that a ComplX can unmarshal to - the use
of magnitude
  -- fixes which unmarshal is the correct one. And, given that magnitude fixes
to what the
  -- hedge is to be unmarshalled, even the unmarshall can be infered.
  r4 = case r3 of {(| :compList[cl @ Wild++] |) ->
                      [magnitude (unmarshal ((create [x] )::ComplX)) | x <-
(decreate cl)]}
  -- another way to do the same thing - note that all the manipulations are just
manipulating the types
  -- and can go away with better analysis
  r5 = case r3 of {(| ::compList[cl @ :complex[Wild, Wild]**] |) ->
                      [magnitude (unmarshal ((cast x)::ComplX)) | (| ( x @
:complex[Wild , Wild] ) |) <- cl] }
  r6 = case r3 of {(| :compList[cl @ :complex[Wild, Wild]**] |) ->
                      (hedgemap getMag cl)::[AnInt]}
  -- in r7 and r8, the decision of how to marshal depends on the type to which
the marshal is to occur
  r7 = ([ :compList[ (decreate ( r::[ComplX] ) ) ] ])::CompList
          where r = (map marshal [3 :+ 4, 4 :+ 5] )
  r8 = ([ :compList[ (decreate ( r::[CompP] ) ) ] ])::CompList
          where r = (map marshal [3 :+ 4, 4 :+ 5] )
  instance (XMark a ( )) => XMark [a] ( ) where
    create x = map (\y -> create [y] ) x
    decreate x = concat (map decreate x)
    value _{—} = value (undefined::a)
```

What is claimed:

1. A computer-programming language for programming a computer, the programming language comprising a type system that includes qualified, polymorphic hedge-regular types.

2. The computer-programming language of claim 1, further comprising a set of patterns allowing bounded decision-making among themselves for potentially infinite computations.

3. The computer-programming language of claim 1, further comprising a combination of hedge-regular data, hedge-regular grammars, regular pattern-matching, and a type variables, the combination yielding polymorphism.

4. The computer-programming language of claim 3, wherein the hedge-regular grammars provides for types, inferences of such types, checking against such types, and sub-typing according to such types.

5. The computer-programming language of claim 3, wherein the type variables are sub-expressions of type expressions.

6. The computer-programming language of claim 1, further comprising one or more weak wildcards that avoid non-determinism by specifically not matching any conflicting particle.

7. The computer-programming language of claim 1, further comprising regex pattern matching with parametric polymorphism.

8. The computer-programming language of claim 7, wherein the regex pattern matching includes determining constraints on type variables.

9. The computer-programming language of claim 7, wherein the constraints are maintained for types with variables, leading to the use of qualified types.

10. A typing system for a programming language, the typing system comprising qualified, polymorphic hedge-regular types.

11. The typing system of claim 10, wherein the types are expressions describing respective sets of values.

12. The typing system of claim 11, wherein the types includes regular expressions over elements, basic types, and type variables.

13. The typing system of claim 12, wherein the values are trees.

14. The typing system of claim 13, wherein the trees include lists of XML items.

15. A type checker for a computer programming language, the computer programming language comprising a type system that includes qualified, polymorphic hedge-regular types, the type checker comprising computer-executable instructions for indicating whether a specific hedge written in the computer-programming language can be assembled in accordance with constraints imposed by the type system.

16. The type checker of claim 15, wherein the hedge is an ordered list of items.

17. The type checker of claim 15, further comprising computer-executable instructions for determining whether a value is of a type that is compatible with a type of a function variable for which the value is provided.

18. The type checker of claim 17, further comprising computer-executable instructions for determining whether the function variable is of a type that is compatible with a type of the function.

19. The type checker of claim 18, further comprising computer-executable instructions for changing the function to perform a different operation based on the type of the variable.

20. The type checker of claim 15, further comprising computer-executable instructions for performing weak matching.
